(19) United States
(12) Patent Application Publication
(10) Pub. No.: US 2025/0128776 A1
(43) Pub. Date: Apr. 24, 2025

(54) Work Vehicle

(71) Applicant: Kubota Corporation, Osaka-shi (JP)

(72) Inventors: Shinya Tabata, Sakai-shi (JP); Seigi Aratake, Sakai-shi (JP); Choru Chon, Sakai-shi (JP); Tetsushi Hamatake, Sakai-shi (JP)

(21) Appl. No.: 18/903,053

(22) Filed: Oct. 1, 2024

(30) Foreign Application Priority Data
Oct. 18, 2023 (JP) 2023-179845

(51) Int. Cl. B62D 63/04; B60K 23/08; B62D 21/02

(52) U.S. Cl. CPC B62D 63/04; B62D 21/02; B60K 23/08; B60K 2023/0883

(57) ABSTRACT

A work vehicle includes a steering wheel attached to a support frame and manually operable to steer the work vehicle; and a speed change operation member attached to the support frame and manually operable to operate a travel transmission device, the support frame being attached to a body frame and allowing the steering wheel and the gear shifter to be attached to the body.

### CROSS-REFERENCE TO RELATED APPLICATION

This application claims priority to Japanese Patent Application No. 2023-179845 filed Oct. 18, 2023, the disclosure of which is hereby incorporated by reference in its entirety.

### BACKGROUND OF THE INVENTION

### Field of the Invention

The present invention relates to a work vehicle with a particular configuration for a steering wheel and its surroundings.

### Description of Related Art

A multipurpose work vehicle as an example work vehicle may, as disclosed in Japanese Unexamined Patent Application Publication, Tokukai, No. 2012-11800, include a steering wheel attached to a body frame (that is, a part of the body) forward of the driver's seat for use to steer the work vehicle. The work vehicle may include a travel shift lever (which is an example of the “speed change operation member”) near the steering wheel and attached to the body frame.

### SUMMARY OF THE INVENTION

Attaching components such as a steering wheel and a shift lever to a body frame (that is, a part of the body) forward of the driver's seat leaves room for improvement in terms of efficiency in producing a work vehicle.

The present invention has an object of providing a work vehicle with improved production efficiency.

A work vehicle of the present invention includes: a body including a body frame and provided with: a travel device; and a transmission device configured to adjust motive power for use to drive the travel device; a support frame attached to the body frame; a steering wheel attached to the support frame and manually operable to steer the work vehicle; and a gear shifter attached to the support frame and manually operable to operate the transmission device, the support frame allowing the steering wheel and the gear shifter to be attached to the body.

With the above configuration, attaching the steering wheel and the gear shifter to the body frame involves first attaching the steering wheel and the gear shifter to the support frame and then attaching the support frame to the body frame. This allows the steering wheel and the gear shifter to be attached to the body.

With the above configuration, attaching the support frame to the body frame allows the steering wheel and the gear shifter to be attached together to the body frame. This simplifies the assembly as compared to attaching the steering wheel and the gear shifter separately to the body, with the result of improved efficiency in producing the work vehicle.

The work vehicle may preferably further include: a power steering motor attached to the support frame and configured to assist operation of the steering wheel; and a steering control device attached to the support frame and configured to operate the power steering motor, wherein the support frame allows the power steering motor and the steering control device to be attached to the body.

The above configuration relates to a work vehicle including a power steering motor and a steering control device to have the function of electric power steering. The steering wheel and the gear shifter are attached to the support frame in advance. Further, the power steering motor and the steering control device are attached to the support frame in advance.

With the above configuration, attaching the support frame to the body frame allows the steering wheel, the gear shifter, the power steering motor, and the steering control device to be attached together to the body frame. This simplifies the assembly, with the result of improved efficiency in producing the work vehicle.

The work vehicle may preferably further include: a brake engageable on the travel device; and a parking brake operation member attached to the support frame and manually operable to keep the brake engaged, wherein the support frame allows the parking brake operation member to be attached to the body.

The above configuration relates to a work vehicle including a parking brake. The steering wheel and the gear shifter are attached to the support frame in advance. Further, the parking brake operation member is attached to the support frame in advance.

With the above configuration, attaching the support frame to the body frame allows the steering wheel, the gear shifter, and the parking brake operation member to be attached together to the body frame. This simplifies the assembly, with the result of improved efficiency in producing the work vehicle.

The work vehicle may preferably be configured such that the travel device includes front wheels and rear wheels, the work vehicle further includes a switching operation member attached to the support frame and manually switchable to set the work vehicle into a four-wheel drive mode, in which the front wheels and the rear wheels are drivable, and a two-wheel drive mode, in which the rear wheels are drivable, and wherein the support frame allows the switching operation member to be attached to the body.

The above configuration relates to a work vehicle switchable between a four-wheel drive mode and a two-wheel drive mode. The steering wheel and the gear shifter are attached to the support frame in advance. Further, the switching operation member is attached to the support frame in advance for setting the work vehicle into the four-wheel drive mode and the two-wheel drive mode.

With the above configuration, attaching the support frame to the body frame allows the steering wheel, the gear shifter, and the switching operation member to be attached together to the body frame. This simplifies the assembly, with the result of improved efficiency in producing the work vehicle.

The work vehicle may preferably be configured such that the body frame includes: a lateral section; and a vertical section, the support frame includes: a first section on and above the lateral section; and a second section on the vertical section, the first section is coupled to the lateral section, and the second section is coupled to the vertical section.

With the above configuration, attaching the support frame to the body frame involves placing the first section of the support frame onto the body frame from above to allow the support frame to be supported by the body frame.

With the above configuration, the support frame is supported by the body frame. This facilitates coupling the lateral section of the body frame to the first section of the support frame and coupling the vertical section of the body frame to the second section of the support frame, with the result of improved efficiency in producing the work vehicle.

### BRIEF DESCRIPTION OF THE DRAWINGS

FIG. 1 is a left side view of a work vehicle.

FIG. 2 is a diagram schematically illustrating the configuration of a travel power transmission system.

FIG. 3 is a rear view of a support frame attached to the body and components such as a steering wheel and a switching lever attached to the support frame.

FIG. 4 is a left side view of a support frame attached to the body and components such as a steering wheel and a switching lever attached to the support frame.

FIG. 5 is a plan view of a support frame attached to the body and components such as a steering wheel and a switching lever attached to the support frame.

FIG. 6 is a front view of a support frame attached to the body and components such as a steering wheel and a switching lever attached to the support frame.

FIG. 7 is a cross-sectional left side view of a support frame being attached to the body (specifically, couplers) and components such as a steering wheel and a switching lever attached to the support frame.

FIG. 8 is a cross-sectional left side view of a support frame being attached to the body (specifically, couplers) and components such as a steering wheel and a switching lever attached to the support frame.

### DESCRIPTION OF THE INVENTION

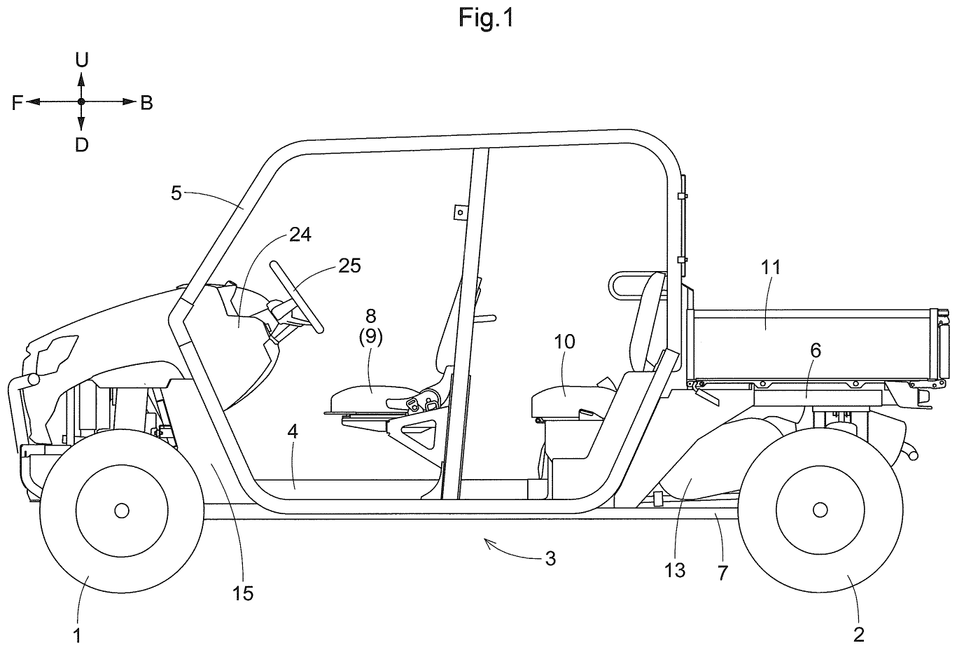

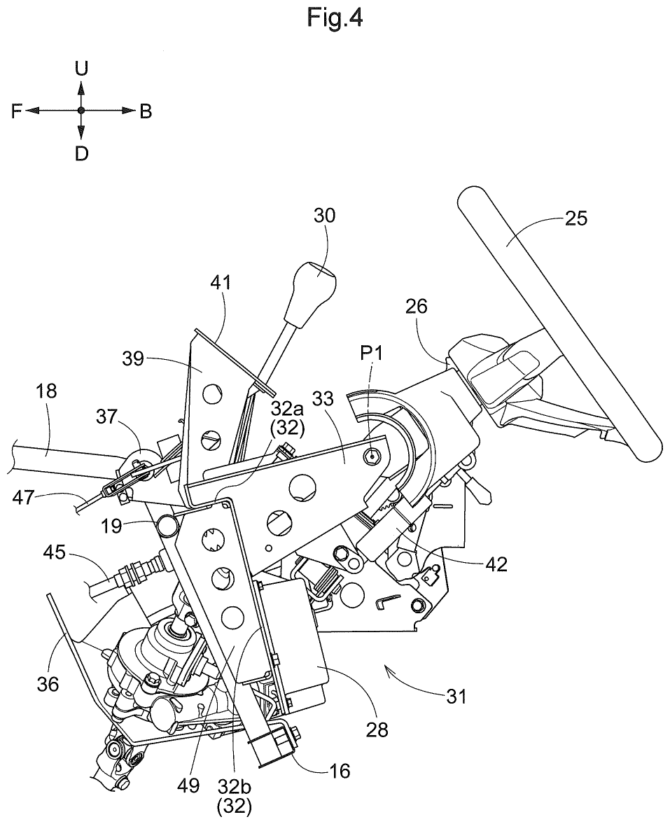

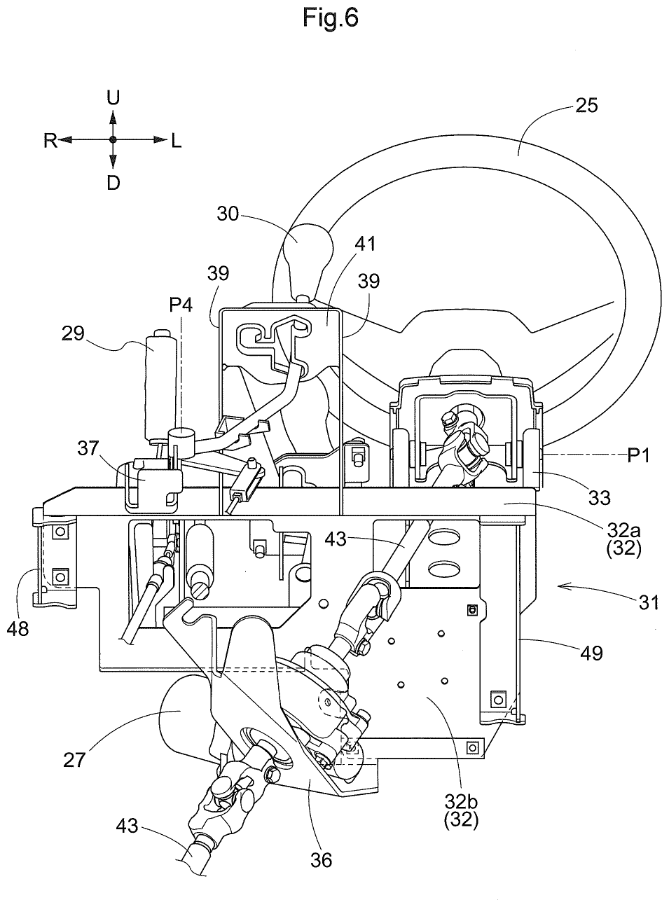

FIGS. 1 to 8 illustrate a multipurpose work vehicle as an example work vehicle. FIGS. 1 to 8 show arrow F to indicate the front side, arrow B to indicate the back side, arrow U to indicate the upward side, arrow D to indicate the downward side, arrow L to indicate the left side, and arrow R to indicate the right side.

### Overall Configuration of Work Vehicle

As illustrated in FIG. 1, the work vehicle includes a body 3, a pair of left and right front wheels 1 at a front portion of the body 3, and a pair of left and right rear wheels 2 at a back portion of the body 3 such that the front and rear wheels 1 and 2 support the body 3. The body 3 includes a floor frame 4, a roll-over protective structure (ROPS) frame 5, a back frame 6, and a lower frame 7.

The work vehicle includes a driver's seat 8 and a passenger's seat 9 forward and a back seat 10 backward on the floor frame 4. The ROPS frame 5 is coupled to the floor frame 4 in such a manner as to cover the driver's seat 8, the passenger's seat 9, and the back seat 10.

### Travel Power Transmission Structure

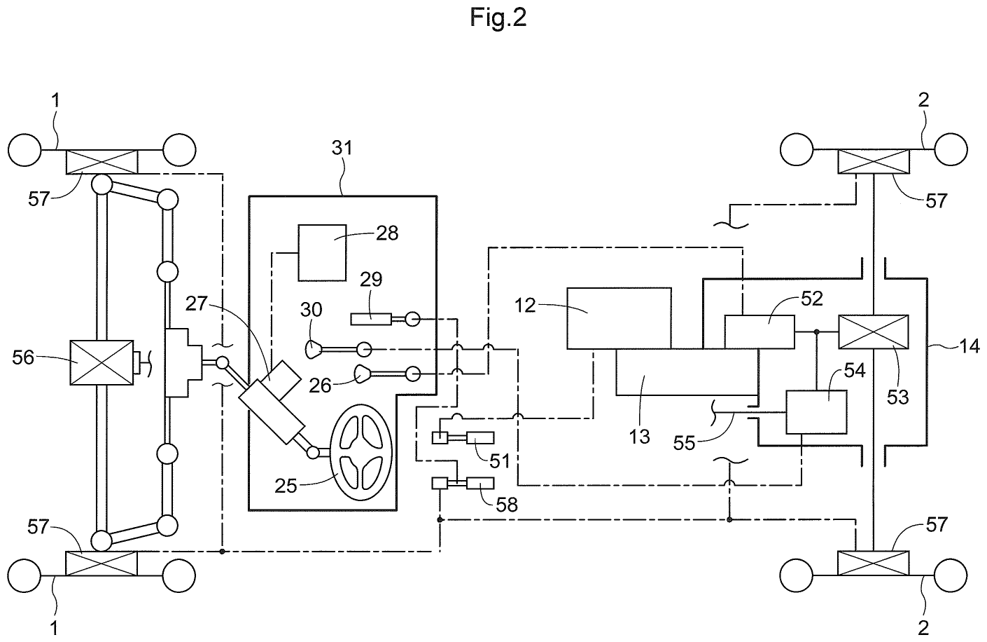

As illustrated in FIGS. 1 and 2, the back frame 6 and the lower frame 7 are each coupled to a back portion of the ROPS frame 5 and extend backward. The work vehicle includes a carrier box 11 on the back frame 6. The work vehicle includes an engine 12, a continuously variable transmission device 13, and a transmission case 14 all disposed on the lower frame 7 as well as the rear wheels 2.

The continuously variable transmission device 13 is a belt-based transmission device. The work vehicle includes an accelerator pedal 51. Pushing the accelerator pedal 51 increases the number of revolutions of the engine 12, which in turn automatically operates the continuously variable transmission device 13 toward the high-speed side. Releasing the accelerator pedal 51 decreases the number of revolutions of the engine 12, which in turn automatically operates the continuously variable transmission device 13 toward the low-speed side.

The transmission case 14 contains an auxiliary transmission device 52, a rear-wheel differential device 53, and a front-wheel power transmission device 54. The auxiliary transmission device 52 (which is an example of the “transmission device”) is a gear-based transmission device capable of shifting to three forward gears and one rearward gear.

The engine 12 transmits motive power to the continuously variable transmission device 13, which varies the motive power and transmits the resulting motive power to the auxiliary transmission device 52, which further varies the motive power and transmits the resulting motive power to the rear-wheel differential device 53, which transmits the motive power to the rear wheels 2. The auxiliary transmission device 52 also transmits motive power through the front-wheel power transmission device 54 and a power transmission shaft 55, which serve as a branch from a position between the auxiliary transmission device 52 and the rear-wheel differential device 53, to a front-wheel differential device 56, which transmits the motive power to the front wheels 1.

Operating the front-wheel power transmission device 54 for four-wheel drive causes the auxiliary transmission device 52 to transmit motive power through the branch to the front wheels 1, so that the work vehicle is in the four-wheel drive mode, in which the front and rear wheels 1 and 2 are both driven. Operating the front-wheel power transmission device 54 for two-wheel drive causes the front-wheel power transmission device 54 to block motive power, so that the work vehicle is in the two-wheel drive mode, in which only the rear wheels 2 are driven.

The work vehicle includes a pair of left and right brakes 57 for the front wheels 1, another pair of left and right brakes 57 for the rear wheels 2, and a brake pedal 58. Pushing the brake pedal 58 activates the brakes 57.

### Configuration of Front Portion of Body and its Surroundings

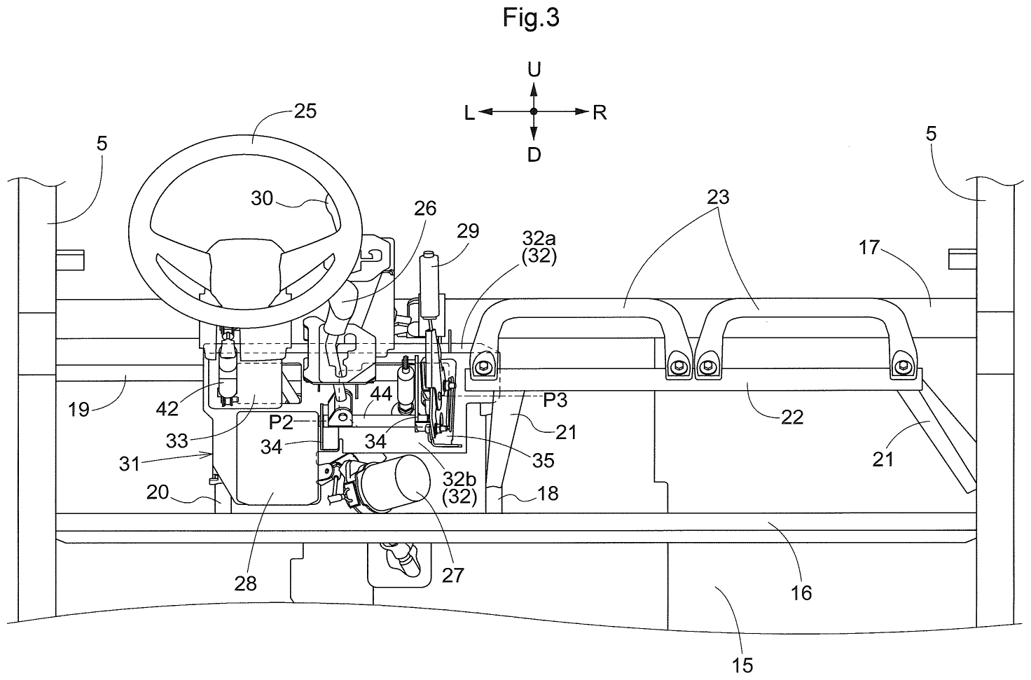

As illustrated in FIGS. 3 to 5, the work vehicle includes (i) a lateral frame member 16 (which is an example of the “body frame”) coupled to respective lower portions of the left and right halves of the ROPS frame 5 and (ii) a lateral frame member 17 (which is an example of the “body frame”) coupled to respective vertically intermediate portions of the left and right halves of the ROPS frame 5.

The work vehicle includes (i) a frame member 18 (which is an example of the “body frame”) coupled to a laterally intermediate portion of the frame member 17 and extending therefrom obliquely forward and downward to be coupled to a laterally intermediate portion of the frame member 16, (ii) a lateral frame member 19 (which is an example of the “body frame”) coupled to a vertically intermediate portion of the left half of the ROPS frame 5 and the frame member 18, and (iii) a vertical frame member 20 (which is an example of the “body frame”) coupled to the frame members 16 and 19.

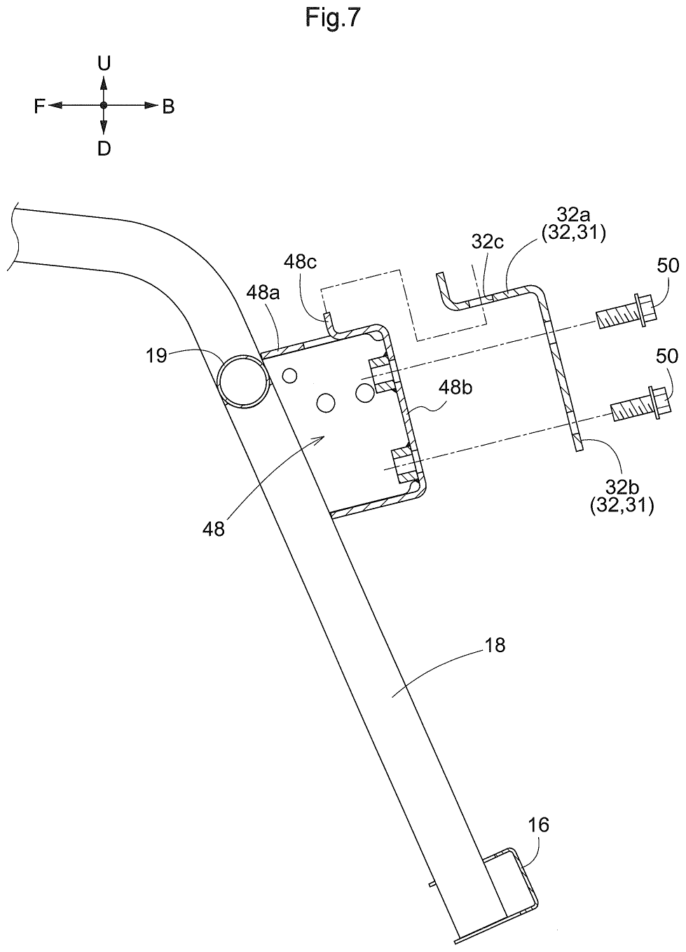

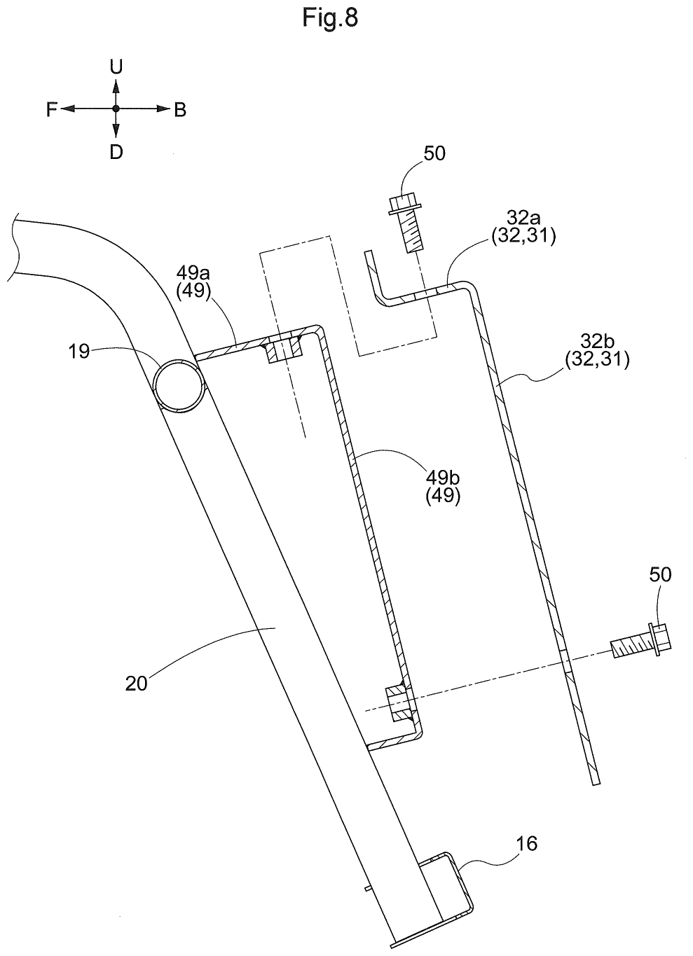

The work vehicle includes (i) a coupler 48 (which is an example of the “body frame”) in the form of a plate bent in the shape of a box and coupled to that portion at which the frame members 18 and 19 are coupled to each other (see FIG. 7) and (ii) a coupler 49 (which is an example of the “body frame”) in the form of a plate bent in the shape of a box and coupled to the frame member 20 (see FIG. 8).

As illustrated in FIGS. 7 and 8, the couplers 48 and 49 include respective upper face portions 48a and 49a (which are an example of the “lateral section”) and respective vertical face portions 48b and 49b (which are an example of the “vertical section”). The coupler 48 includes a protrusion 48c on the upper face portion 48a. The vertical frame members 18 and 20 are arranged laterally, so that the upper face portions 48a and 49a are laterally apart from each other.

The frame members 18 and 20 are each inclined forward such that an upper portion thereof is forward of a lower portion thereof. The vertical face portions 48b and 49b are thus each inclined forward such that an upper portion thereof is forward of a lower portion thereof.

As illustrated in FIGS. 1 and 3, the work vehicle includes a front panel 15 coupled to the floor frame 4, respective lower portions of the left and right halves of the ROPS frame 5, and the frame member 17 and separating the front wheels 1 on the body 3 and their surroundings from the driver's seat 8, the passenger's seat 9, and their surroundings. The work vehicle includes a synthetic resin panel 24 attached to the frame members 16 to 20. The front panel 15, the frame members 16 to 20, and the couplers 48 and 49 are each a part of the body 3.

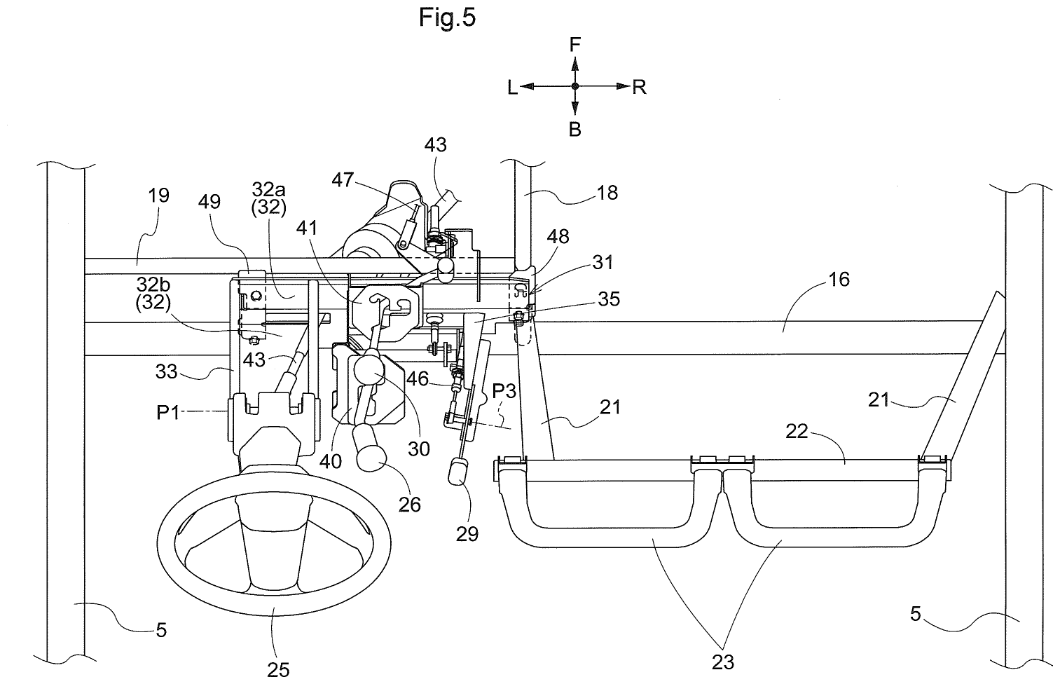

As illustrated in FIGS. 3 and 5, the work vehicle includes a left arm 21 coupled to the frame member 18 and extending backward, a right arm 21 coupled to the right half of the ROPS frame 5 and extending backward, and a lateral frame member 22 coupled to the arms 21. The work vehicle includes two auxiliary handles 23 forward of the passenger's seat 9 and coupled to the frame member 22.

### Outline of Structure for Attaching Steering Wheel and Others to Body

As illustrated in FIGS. 2 to 5, the work vehicle includes a steering wheel 25 for use to manually change the direction of the front wheels 1 and a shift lever 26 (which is an example of the “gear shifter”) for use to manually operate the auxiliary transmission device 52 in the transmission case 14 for a shift to three forward gears and one rearward gear.

The work vehicle includes a power steering motor 27 configured to assist the operation of changing the direction of the front wheels 1 with use of the steering wheel 25 and a steering control device 28 configured to activate the power steering motor 27.

The work vehicle includes a parking brake lever 29 (which is an example of the “parking brake operation member”) for use to activate and hold the brakes 57 and a switching lever 30 (which is an example of the “switching operation member”) for use to operate the front-wheel power transmission device 54 for four-wheel drive or two-wheel drive.

The work vehicle includes a support frame 31 described below, to which are attached the steering wheel 25, the shift lever 26, the power steering motor 27, the steering control device 28, the parking brake lever 29, and the switching lever 30.

The support frame 31 is attached to the frame members 16 and 18 to 20 and the couplers 48 and 49, so that the steering wheel 25, the shift lever 26, the power steering motor 27, the steering control device 28, the parking brake lever 29, and the switching lever 30 are attached to the body 3 (specifically, the frame members 16 and 18 to 20 and the couplers 48 and 49) with the support frame 31 in-between.

### Configuration of Support Frame

As illustrated in FIGS. 3 to 6, the support frame 31 includes a substrate 32, supports 33 to 37, brackets 38 and 39, and lever guides 40 and 41.

The substrate 32 is in the form of a plate so bent as to include an upper portion as a first section 32a with the remaining portion as a second section 32b extending downward from the first portion 32a.

The support 33 is bent in the shape of a channel and coupled to a left portion of the back face of the second section 32b, and extends backward.

The left and right supports 34 are each coupled to a portion of the second section 32b which portion is near the lateral center of its back face, and extend backward.

The support 35 is coupled to a right portion of the back face of the second section 32b and extends backward.

The support 36 is coupled to a lower portion of the front face of the second section 32b. The support 37 is coupled to a right portion of the first section 32a.

The bracket 38 is coupled to an upper portion of the second section 32b which upper portion is near its lateral center and extends backward. The lever guide 40 is coupled to the bracket 38.

The bracket 39 is coupled to an upper portion of the first section 32a which upper portion is near its lateral center and extends backward. The lever guide 41 is coupled to the bracket 39.

### Attachment to Support Frame of Steering Wheel, Shift Lever, Power Steering Motor, Steering Control Device, Parking Brake Lever, and Switching Lever

As illustrated in FIGS. 3 to 6, the steering wheel 25 includes a base attached to the support 33 in such a manner that the steering wheel 25 has an orientation changeable (that is, is tiltable) about a lateral axis P1. The work vehicle includes a tilt cylinder 42 attached to the support 33 and the base of the steering wheel 25 and configured to urge the steering wheel 25 upward.

The work vehicle includes a steering shaft 43 extending from the steering wheel 25 obliquely forward and downward. The power steering motor 27 is attached to the support 36 and configured to act on the steering shaft 43. The steering control device 28 is attached to a portion of the second section 32b which portion is below the support 33.

The work vehicle includes an operation shaft 44 attached to the supports 34 and swingable about a lateral axis P2 and an operation wire 45 connected to the operation shaft 44 and the auxiliary transmission device 52 (see FIG. 2). The shift lever 26 is attached to the operation shaft 44 and extends upward through the lever guide 40.

The parking brake lever 29 is attached to the support 35 and swingable about a lateral axis P3. The work vehicle includes an operation wire 46 connected to the parking brake lever 29 and the operation system for the brakes 57.

The switching lever 30 is attached to the support 37 and swingable about a vertical axis P4, and extends upward through the lever guide 41. The work vehicle includes an operation wire 47 connected to the switching lever 30 and the front-wheel power transmission device 54 (see FIG. 2).

### Description Corresponding to Claims That Supports Support Frame

The work vehicle includes:
a body 3 including a body frame (that is, the frame members 16 to 20 and couplers 48 and 49) and provided with: a travel device (that is, the front and rear wheels 1 and 2) and a transmission device (that is, the auxiliary transmission device 52) configured to adjust motive power for use to drive the transmission device (that is, the front and rear wheels 1 and 2);
a support frame 31 attached to the body frame (that is, the frame members 16 to 20 and couplers 48 and 49);
a steering wheel 25 attached to the support frame 31 and manually operable to steer the work vehicle; and
a gear shifter (that is, the shift lever 26) attached to the support frame 31 and manually operable to operate the transmission device (that is, the auxiliary transmission device 52),
the support frame 31 allowing the steering wheel 25 and the gear shifter (that is, the shift lever 26) to be attached to the body 3.

The work vehicle may include:
a power steering motor 27 attached to the support frame 31 and configured to assist operation of the steering wheel 25; and
a steering control device 28 attached to the support frame 31 and configured to operate the power steering motor 27,
wherein the support frame 31 allows the power steering motor 27 and the steering control device 28 to be attached to the body 3.

The work vehicle may include:
a brake 57 engageable on the travel device (that is, the front and rear wheels 1 and 2); and
a parking brake operation member (that is, the parking brake lever 29) attached to the support frame 31 and manually operable to keep the brake 57 engaged,
wherein the support frame 31 allows the parking brake operation member (that is, the parking brake lever 29) to be attached to the body 3.

The work vehicle may be configured such that
the travel device includes front wheels 1 and rear wheels 2,
the work vehicle further includes a switching operation member (that is, the switching lever 30) attached to the support frame 31 and manually switchable to set the work vehicle into a four-wheel drive mode, in which the front wheels 1 and the rear wheels 2 are drivable, and a two-wheel drive mode, in which the rear wheels 2 are drivable, and
wherein the support frame 31 allows the switching operation member (that is, the switching lever 30) to be attached to the body 3.

### Attachment of Support Frame to Body

The steering wheel 25, the shift lever 26, the power steering motor 27, the steering control device 28, the parking brake lever 29, and the switching lever 30 are attached to the support frame 31. As illustrated in FIGS. 7 and 8, the first section 32a of the support frame 31 (specifically, the substrate 32) includes a right portion with an opening 32c through which the protrusion 48c of the coupler 48 is disposed.

The first section 32a includes left and right portions above and on the respective upper face portions 48a and 49a of the couplers 48 and 49.

The second section 32b of the support frame 31 (specifically, the substrate 32) includes left and right portions backward of and on the respective vertical face portions 48b and 49b.

The upper face portions 48a and 49a, which are laterally apart from each other, support the support frame 31 and prevent it from falling.

The vertical face portions 48b and 49b, which are each inclined forward, allow the support frame 31 to be thereon stably.

The protrusion 48c, which is disposed through the opening 32c, prevents the support frame 31 from being moved easily in the lateral or front-back direction.

In the above state, the second section 32b includes a right portion coupled to the vertical face portion 48b with use of a bolt 50.

The first section 32a includes a left portion coupled to the upper face portion 49a with use of a bolt 50.

The second section 32b includes a lower left portion coupled to the vertical face portion 49b with use of a bolt 50.

Coupling the support frame 31 (specifically, the substrate 32) to the couplers

48 and 49 as above attaches the support frame 31 to the frame members 16 and 18 to 20. The steering wheel 25, the shift lever 26, the power steering motor 27, the steering control device 28, the parking brake lever 29, and the switching lever 30 are attached to the body 3 (specifically, the frame members 16 and 18 to 20 and the couplers 48 and 49) with the support frame 31 in-between.

### Description Corresponding to Claims That Supports Attachment of Support Frame to Body

The work vehicle may be configured such that
the body frame (that is, the frame members 16 to 20 and couplers 48 and 49) includes:
   a lateral section (that is, the upper face portions 48a and 49a); and
   a vertical section (that is, the vertical face portions 48b and 49b),
the support frame 31 includes:
   a first section 32a on and above the lateral section (that is, the upper face portions 48a and 49a); and
   a second section 32b on the vertical section (that is, the vertical face portions 48b and 49b),
the first section 32a is coupled to the lateral section (that is, the upper face portions 48a and 49a), and the second section 32b is coupled to the vertical section (that is, the vertical face portions 48b and 49b).

### First Alternative Embodiment

The first section 32a of the support frame 31 (specifically, the substrate 32) includes a right portion with an opening 32c through which the protrusion 48c of the coupler 48 is disposed. The right portion of the first section 32a may additionally be coupled to the upper face portion 48a of the coupler 48 with use of a bolt 50.

### Second Alternative Embodiment

The frame member 19 may have a flat upper face to allow the first section 32a as a whole to be above and on the upper face.

### Third Alternative Embodiment

The power steering motor 27 may be attached not to the support frame 31 but to the frame member 16.

The work vehicle may omit the power steering motor 27 and the steering control device 28.

### Fourth Alternative Embodiment

The work vehicle may omit the switching lever 30 if the work vehicle does not include the front-wheel power transmission device 54.

With this configuration, the work vehicle is a four-wheel drive vehicle with constantly drivable front and rear wheels 1 and 2 or a two-wheel drive vehicle with constantly undrivable front wheels 1 and constantly drivable rear wheels 2.

### Fifth Alternative Embodiment

The belt-based continuously variable transmission device 13 may be replaced with a hydrostatic continuously variable transmission device (which is an example of the “transmission device”) operable with use of the shift lever 26.

### Sixth Alternative Embodiment

The engine 12 may be replaced with an electric motor (not illustrated in the drawings) as a motive power source for an electrically operated work vehicle.

The engine 12 may be combined with an electric motor (not illustrated in the drawings) as motive power sources for a hybrid work vehicle.

### INDUSTRIAL APPLICABILITY

The present invention is applicable not only to work vehicles including front wheels 1 and rear wheels 2, but also to work vehicles including front wheels 1 and rear crawler travel devices (which is an example of the “travel device”) and to work vehicles including a pair of left and right crawler travel devices instead of front and rear wheels 1 and 2.

### REFERENCE SIGNS LIST

1 Front wheel (travel device)
2 Rear wheel (traveling device)
3 Body
52 Auxiliary transmission device (transmission device)
16 Frame member (body frame)
17 Frame member (body frame)
18 Frame member (body frame)
19 Frame member (body frame)
20 Frame member (body frame)
25 Steering wheel
26 Shift lever (gear shifter)
27 Power steering motor
28 Steering control device
29 Parking brake lever (parking brake operation member)
30 Switching lever (switching operation member)
31 Support frame
32a First section
32b Second section
48 Coupler (body frame)
48a Upper face portion (lateral section)
48b Vertical face portion (vertical section)
49 Coupler (body frame)
49a Upper face portion (lateral section)
49b Vertical face portion (vertical section)
57 Brake

1. A work vehicle, comprising:
a body comprising a body frame and provided with:
a travel device; and
a transmission device configured to adjust motive power for use to drive the travel device;
a support frame attached to the body frame;
a steering wheel attached to the support frame and manually operable to steer the work vehicle; and
a gear shifter attached to the support frame and manually operable to operate the transmission device, and
wherein the support frame allows the steering wheel and the gear shifter to be attached to the body.

2. The work vehicle according to claim 1, further comprising:
a power steering motor attached to the support frame and configured to assist operation of the steering wheel; and
a steering control device attached to the support frame and configured to operate the power steering motor, and
wherein the support frame allows the power steering motor and the steering control device to be attached to the body.

3. The work vehicle according to claim 1, further comprising:
a brake engageable on the travel device; and
a parking brake operation member attached to the support frame and manually operable to keep the brake engaged, and
wherein the support frame allows the parking brake operation member to be attached to the body.

4. The work vehicle according to claim 1, wherein:
the travel device comprises front wheels and rear wheels,
the work vehicle further comprises a switching operation member attached to
the support frame and manually switchable to set the work vehicle into a four-wheel drive mode in which the front wheels and the rear wheels are drivable, and a two-wheel drive mode in which the rear wheels are drivable, and
the support frame allows the switching operation member to be attached to the body.

5. The work vehicle according to claim 1, wherein:
the body frame comprises:
a lateral section; and
a vertical section,
the support frame comprises:
a first section on and above the lateral section; and
a second section on the vertical section,
the first section is coupled to the lateral section, and
the second section is coupled to the vertical section.
